(19) United States
(12) Patent Application Publication
(10) Pub. No.: US 2007/0033070 A1
(43) Pub. Date: Feb. 8, 2007

(54) System and method for collecting payments from service recipients

(76) Inventors: G. Douglas Beck, Woodinville, WA (US); Richard C. Auger, St. Helena, CA (US); Bradley H. Loose, Burlingame, CA (US); Allen W. Puckett, Seattle, WA (US); Catherine C. Roth, Oakland, CA (US); Roxann G. Loose, Burlingame, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/492,279

(22) Filed: Jul. 24, 2006

Related U.S. Application Data
(60) Provisional application No. 60/702,395, filed on Jul. 25, 2005.

(51) Int. Cl. G06Q 10/00; G06Q 40/00

(52) U.S. Cl. 705/2; 705/40

(57) ABSTRACT

A computer-based method of collecting payment for a service is presented. The method includes capturing a service that is rendered for a service recipient by a service provider and, if there is a third party payer in contract with the service recipient to pay at least part of the cost for the service, determining a relationship between the third party payer and the service provider that defines a preliminary allowed amount to be collected by the service provider for the service. Of the preliminary allowed amount, a first portion that is to be collected from the service recipient for the service is determined. The computer automatically collects the first portion from the service recipient on the date of service. In one embodiment, the method provides a universal platform with which healthcare providers can collect payments from patients and various third party payers.

### CROSS-REFERENCE TO RELATED APPLICATION

This patent application claims the benefit of priority from U.S. Provisional Patent Application No. 60/702,395 filed on Jul. 25, 2005, the content of which is incorporated by reference herein.

### FIELD OF INVENTION

This invention pertains generally to a payment management and collection system and particularly to a patient payment management and control system for healthcare providers.

### BACKGROUND

Most healthcare providers collect significantly less than the full fees they are entitled to receive from patients. Most of the fees they do receive arrive months after the date of service, and the amounts providers spend on billing and collection sometimes exceed the amounts they collect. In addition, most providers lack basic operational and financial controls such as reports by payment type that can be reconciled against patient activity, receipts and deposits, on a daily, weekly, or monthly basis. This lack of financial controls is widely believed and has been observed to result in significant losses due to employee fraud, embezzlement, and incompetence.

Healthcare providers face this situation because at the time they perform services for patients with commercial or employer-underwritten insurance (usually a majority of their patients) neither the provider nor the patient knows the insurer-contracted price (the amount the physician is contractually allowed to charge the patient) for those services. It frequently takes 4-6 weeks for a patient's insurer to determine the total amount a physician is entitled to receive, calculate and pay the provider the insurer's share of that amount, if any, and send the doctor an Explanation of Payment (EOP) and the patient an Explanation of Benefits (EOB) that shows the balance due from the patient. Only then can the physician send an exact bill to the patient requesting payment. The process takes even longer for hospital-based services.

In addition, both provider bills for health care services and plan EOBs are famously difficult for patients to interpret—so difficult that patients often cannot determine whether or how much to pay and to whom. This difficulty, combined with bills and EOBs received months after services were rendered and payments that require writing a check and stamping and mailing an envelope, means that medical bills often are set aside instead of being paid when due. This forces providers to send multiple follow-up bills and often leads to delinquent accounts being turned over to collection agencies or written off.

The few solutions on the market today that attempt to increase the amounts providers receive from patients or to reduce the time required to collect them have taken one of four forms. These solutions have limited effectiveness.

The first has been to encourage physicians to accept credit cards, including holding credit card numbers on file in order to collect outstanding amounts due when the amounts due become known. There is in fact high penetration of credit card processing availability in physician offices. As a practical matter, however, credit cards are used only to collect patient copays—relatively small fixed payments required each time a patient visits a provider—rather than the much larger amounts patients pay to satisfy deductible and coinsurance requirements.

The second has been to enhance provider billing systems so they can retain information about plan and network fee schedules and patient benefit structures. Fee schedules determine the total amount a provider can collect for the services provided to a patient, while patient benefits information determines how much of the total amount will be paid by the plan and how much by the patient. Such enhanced billing systems are found in only a minority of provider settings. They typically capture data covering only a limited number of plans and rarely if ever provide for systematic updates to ensure that stored information is accurate. Most important, they do not combine ways to collect information on services provided by the provider with calculations of amounts that will be due from a patient and an electronic means of collecting those amounts at the time of service nor do they make electronic adjustments (instead of sending bills or issuing refunds) if the amount collected at the time of service is determined to be incorrect when the provider's claim to the insurer finally is adjudicated.

A third set of solutions has been proposed or implemented by the insurance companies, and health plans that underwrite or administer health care benefits for patients served by the healthcare providers (payers). These consist of ways for physicians to access near real-time information from payers about the amounts likely to be due from its members, or, in a very few cases, real-time claims adjudication that tells providers the exact amounts due from patients within minutes of when the service is completed so they can collect those amounts at that time. Near real-time estimation by payers is being tested on a very limited basis in a few markets. Real-time adjudication is even rarer, available in only a few states and from a very few payers. While it theoretically allows the physician office to know and collect from the patient as soon as the adjudication results are known for that day's service, there again is no link between those results and a method of collecting the patient's portion of the amount owed for the service. Finally, by definition, information from a single payer is only relevant to patients covered by that payer. Providers typically serve patients enrolled in dozens of health plans (at least); patients from any single health plan usually account for less than 20 percent of the total. Even if multiple payers delivered real-time estimation or adjudication directly to providers, differences in how payers implemented their respective solutions most likely would require the providers to use a separate workflow for the patients insured by each payer.

The fourth approach involves secure Internet sites that patients can check to determine amounts owing and to pay them. This approach can be more cost-effective than billing if it is possible to notify patients via personal emails that a bill is available for payment and if the patients then follow through, access the payment web site and use secure web links to pay their bill with a credit card. The limitations are that they require the provider to have a payment web site and the patient to have a personal computer, an Internet connection, a personal email account, and the ability and willingness to use a web site to pay bills.

In summary, prior efforts to improve the patient collection process provide limited benefits because they offer only partial solutions. Attempts to eliminate billing by capturing and storing credit card numbers in the insecure environment of a physician office place both patients and physicians at risk. Attempts by health plans or by the vendors of PMS or other billing and accounting systems to help providers collect at the time of service require a lot of work from the provider, yet serve only a portion of the provider's patients and services. The work includes gathering fee schedules and benefit information from payers willing and able to provide them; processing the varying information available from each payer to conform to the requirements of the providers' specific accounting and billing system; designing and implementing office processes and procedures to collect the codes describing services received by the patient before he or she leaves the office; informing patients that belong to the health plans willing to provide fee and benefits data of a new financial policy (“collect total amounts due at time of service”); and designing input processes and ways to process and present the varying data in an identical format that allows office staff to inform each patient of his or her responsibility and collect amounts due as the final step in the patient's visit. Because of the way the data is stored and managed, the actual calculation of the patient's financial responsibility remains largely manual. In addition, to the extent that collections are based on inexact estimates, when the plan provides its EOP to the provider and corresponding EOB to the patient, the provider must bill and collect (or refund) a small amount of money. While the transaction may be smaller, it entails the same hassles and expense of current billing practices for both the provider and the patient in addition to the new hassle of coping with a payment transaction at the time of checkout.

While the industry has gradually streamlined payer billing through electronic data interchange and funds transfer (EDI and EFT) between the healthcare provider and the insurance company or health plan, this has had only a minor impact on collecting from patients. Similarly, out-source billing and “revenue cycle management” services have improved claims coding and expedited transmission to plans and other third-party payers, but print and mail patient bills similarly to the way providers do and have little impact on revenues from patients. Finally, one-on-one efforts to match the diverse information offerings of individual payers with the equally diverse information processing environments and capabilities of individual providers fail because they require too much work on both sides and require providers to “stream” patients through different work flows. For most providers managing multiple parallel workflows depending on the patients' insurance status is simply not practical. Healthcare providers have until now had no way to avoid the lost revenues, high expenses, and patient and professional dissatisfaction stemming from the patient insurance and reimbursement systems that characterize today's healthcare system in certain countries, such as the United States.

### SUMMARY

In one aspect, the invention is a computer-based method of collecting payment for a service. The method includes capturing a service that is rendered for a service recipient by a service provider and determining if there is a third party payer in contract with the service recipient to pay at least part of the cost for the service. If there is a third party payer in contract with the service recipient, a relationship between the third party payer and the service provider is determined and this relationship is used to determine a preliminary allowed amount to be collected by the service provider for the service. Of the preliminary allowed amount, a first portion that is to be collected from the service recipient for the service is determined. The computer automatically collects the first portion of the preliminary allowed amount from the service recipient on the date of service.

In another aspect, the invention is a computer-readable storage medium storing instructions for a computer to perform the above method.

### BRIEF DESCRIPTION OF THE DRAWINGS

FIG. 1 is an overview of a payment management system in accordance with the invention.

FIG. 2 is a flowchart illustrating a setup and configuration process that is executed by the payment management system.

FIG. 3 is a flowchart illustrating a patient scheduling process that is executed by the payment management system.

FIG. 4 is a flowchart illustrating a patient check-in and encounter set-up process that is executed by the payment management system.

FIG. 5A is a flowchart illustrating a patient check-out and payment collection process that is executed by the payment management system.

FIG. 5B is a flowchart illustrating the details of the process executed by Payment Management Computer to determine the preliminary allowed amount that will be received by healthcare provider.

FIG. 6 is a flowchart illustrating a payment posting and settle-up process from an electronic remittance advice (HIPAA 835) that is executed by the payment management system.

FIG. 7 is a flowchart illustrating a payment posting and settle-up process from a paper remittance advice that is executed by the payment management system.

FIG. 8 is a flowchart illustrating a periodic fee schedule and contract maintenance process that is executed by the payment management system.

FIG. 9 is a flowchart illustrating daily financial controls that are executed by the payment management system.

### DETAILED DESCRIPTION OF THE EMBODIMENT(S)

The patient management and control system provided by this invention solves the problems described earlier by providing a universal workflow for all patients, whether they are uninsured, covered by large insurance companies, employees of a small self-insured employer, or part of a government program. It can be implemented in a variety of ways to suit the unique needs of regional markets and individual providers within those markets (e.g., as an independent, self-contained and maintained system in a large provider environment, or as a shared service accessed via an Internet browser). It can work independently or collaboratively with existing provider billing and accounting systems either by exchanging data via system-specific interfaces or by sharing common patient and/or fee schedule databases. In the latter case, the patient management and control system would be delivered as a web service and embedded within the provider's existing accounting and billing system and its functions would appear to be additional functions of the existing system.

For each patient encounter, the patient management and control system described herein presents and calculates the same information to a provider's front-office staff. It tells them what to collect, lets them scan and store in an encrypted database one or more electronic pay methods from each patient (e.g., a credit or debit card or ACH or PayPal account information), completes the electronic collection process, and provides email and/or hard-copy receipts. If the EOPs and EOBs produced after the provider's claim is adjudicated by a plan or TPA show that the amount collected from the patient at the time of service was too little or too much, it allows the practice to collect (or refund) the difference electronically (“settle-up”), sending a receipt or refund notice to the patient rather than a bill or a credit statement.

The invention can be a universal payment system for all patients, regardless of their insurance status or choice of insurance plan, because it specifically allows for the simultaneous use of various information sources with various currency and accuracy, always using the best available information that can be obtained from a patient's contracted third-party payer with respect to the patient's benefits and the total allowable fees that can be collected by the provider. If precise, real-time adjudication is available, the system will access that information and make it available to a Payment Management Computer (described below) to initiate immediate collection of the full amount due, eliminating the need for later reconciliation or “settle-up” transactions to adjust for errors in the amounts collected at time of service. If limited or no contract fee data is available, it can approximate the amount by referencing applicable Medicare schedules and apply industry-standard copay and coinsurance assumptions.

The combination of functions embodied in the invention above is highly synergistic. The flexible all-payer, all-patient estimating function and the multiple ways the system can be deployed allow it to function in any healthcare provider environment, regardless of the mix of patients and contracted third party payers. The ability to collect at time of service and reduce the uncertainty associated with remaining payments as well as the highly secure infrastructure for storing electronic pay methods encourage patients to provide payment methods that eliminate the need for follow-up billing and collection.

The system benefits third party payers, third-party administrators (TPAs) and patients as well as providers. Payers and TPAs can deploy information services related to patient collection at their own pace, on the one hand deferring investments with limited returns or on the other proceeding immediately to capture savings from the replacement of paper transactions and elimination of rejected claims and support their provider networks. In either case, payers and TPAs will face less pressure to coordinate their service offerings with the capabilities of specific provider systems or to stage their deployment in concert with others' deployment schedules to ensure there is sufficient critical mass to guarantee their use.

There are also benefits to patients as well. The availability of time of service collection provides new insight into the costs they bear in connection with their health and health care choices. And the use of secure electronic collection systems eliminates security risks, the need to interpret opaque EOPs and bills long after the fact, the need to write checks and mail frequent small payments to their healthcare providers, and the risks that an incorrect interpretation of a bill or an accidental late payment will trigger collection actions that affect their credit rating.

The invention includes a software system and accompanying methods that allow healthcare providers to (1) adopt patient financial policies requiring payment of actual or estimated amounts due at the time of service; (2) calculate amounts due from self-insured patients and estimate amounts due from insured patients at the time they receive health care services; (3) obtain from patients and use the full range of electronic payment methods including credit cards, debit cards, ACH transactions and Internet payment systems such as PayPal, incorporated in a single medical merchant system, to pay amounts due or estimated to be due from patients at the time they receive health care services; (4) use the same electronic payment methods to collect additional amounts due or refund excess amounts collected when ex post facto health plan Explanations of Benefits and Explanations of Payments document the allowable amounts healthcare providers may collect from their patients under the terms of their direct or indirect agreements with the plans, and; (5) enforce comprehensive collection tracking and controls to reduce or eliminate revenue “leakage” due to missed billing opportunities, internal fraud, or embezzlement.

The invention uses a variety of methodologies to calculate or estimate the fees a provider has contracted to accept with each health plan or insurance company.

The invention includes the ability to reconcile the total amount due with amounts collected at the time of service in cases where the amount due could not be accurately determined at the time of service.

The invention can include self-correcting fee schedule maintenance to ensure that fees become increasingly accurate over time.

The invention allows healthcare providers to collect from patients and use a wide variety of electronic payment methods in a single integrated medical merchant system without exposing either patients or service providers to the risk of storing patient financial data, such as credit card numbers, on paper, in clinical charts, or in insecure computer systems.

The invention tracks all patient owed amounts and payments received immediately upon receipt so they can be reconciled daily with the service provider's billing and accounting systems (herein referred to as the practice management system) and with transactions reported by the provider's bank and electronic transaction intermediaries. As used herein, a “patient” or a “service recipient” is intended to include not only the recipient of a service (e.g., a medical service) but also anyone who is responsible for payment for the service, including but not limited to the service recipient's guarantor or guardian. A “healthcare provider” is intended to encompass professionals such as physicians and non-physician care givers like acupuncturists, chiropractors and physical therapists as well as allied healthcare professionals such as audiologists, dentists, and optometrists plus facilities such as hospitals, surgicenters and diagnostic test laboratories and imaging centers. In the context provided herein, a “healthcare provider” can be either the overall organization as a potential contracting party (e.g., a hospital, clinic) as well as the individual healthcare providers (e.g., Dr. Smith) within the organization who may have separate, additional contractual relationships with payers

Although the system and method of the invention are described herein in the context of the U.S. healthcare industry, the utility of the invention is not limited to any particular industry and may be adapted for other industries that have a similar payment scheme.

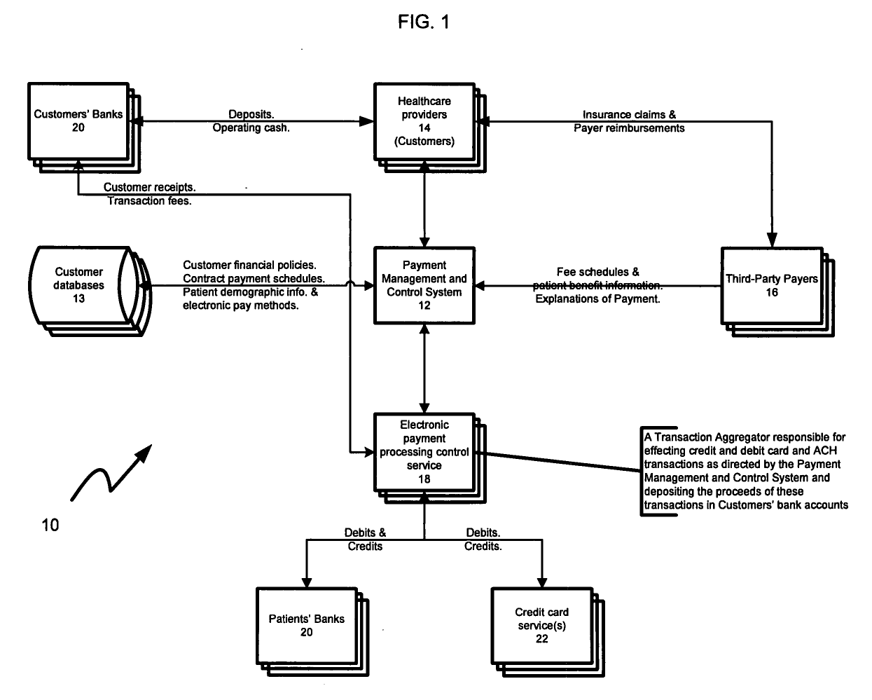

FIG. 1 provides an overview of a payment management system 10 in accordance with the invention. As shown, the payment management system 10 includes a Payment Management Control Computer System 12 (“Payment Management Computer 12”) that communicates with and manages and tracks patient financial transactions for one or more healthcare providers 14. If the Payment Management Computer 12 is deployed by or on behalf of a single health care service provider 14, it could support staff members, physicians and other workers located at one or multiple sites controlled by that provider organization. If the Payment Management Computer 12 is operated by an independent application service provider, the healthcare providers 14 could represent separate customers, each of which could operate one or more clinics, physician practices, or facilities such as surgical centers or hospitals.

The Payment Management Computer 12 also communicates with and/or stores data received from the one or more third-party payers 16, which include all payers in contract both with patients served by the healthcare providers 14 and with healthcare provider 14 or its individual care providers. These communications confirm patient eligibility and benefits, and in some cases may include information about the exact or approximate amount the healthcare providers 14 will receive for rendering specific care services and how much of that amount will be paid by the insurance company or health plan and how much by the patient.

The Payment Management Computer 12 communicates as well with one or more electronic payment processing networks 18 that authenticate and transmit electronic patient payment transactions initiated by the healthcare providers 14. These transactions transfer funds from a patient's bank account or credit account to a healthcare provider's deposit account. Some payment processing networks (e.g. TransFirst or First Data) execute traditional ACH and credit and debit card transactions; others (e.g. PayPal) add intermediary payment services that eliminate the need for patients to share their account information with merchants. In all cases, however, the payment processing networks 18 provide secure access to patient banks 20, healthcare provider's banks 21, and credit and debit card services 22 such as Visa International, MasterCard, American Express and Discover as well as private-label card services linked to patient Health Savings Accounts.

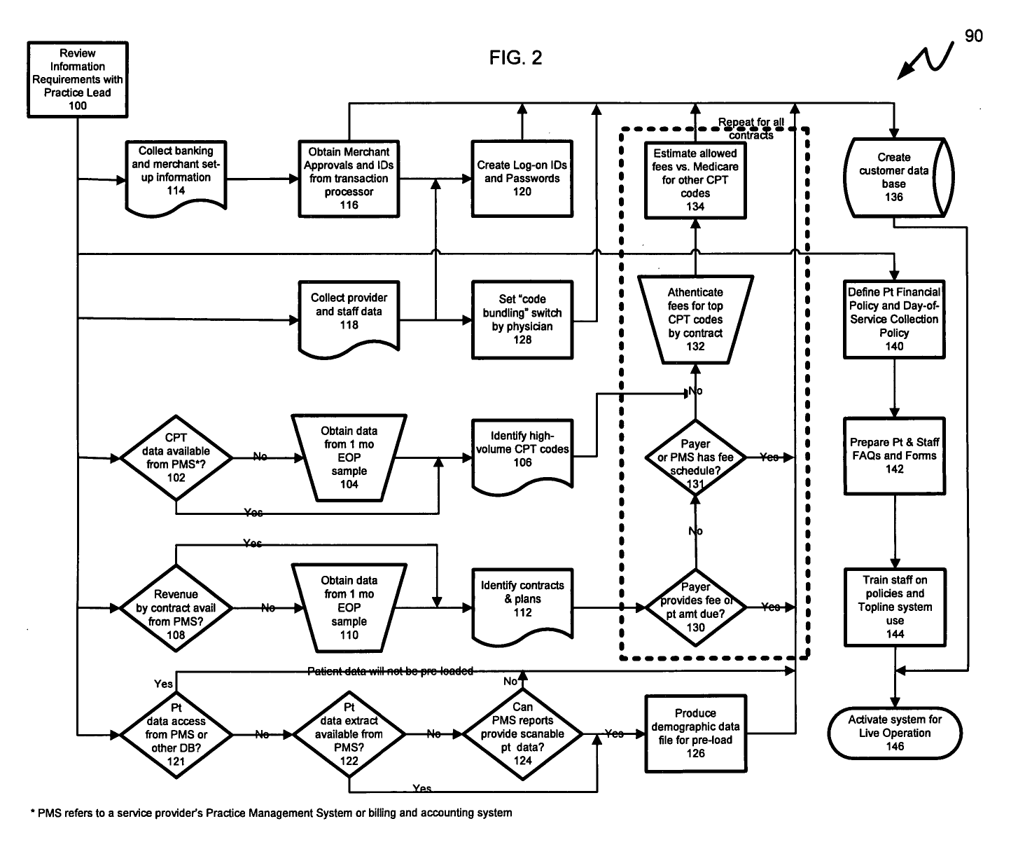

Finally, the Payment Management Computer 12 maintains one or more customer databases 13 containing information about patient eligibility and benefits; healthcare services received from and patient amounts paid or owing to the healthcare providers 14; various policy settings defined by the healthcare providers; and additional data more particularly described in the discussion of FIG. 2 below. Each database 13 supports a healthcare services organization that is a single legal and financial entity (e.g. a corporation, partnership, LLC or professional services corporation), although that organization may have many types and sites of service. Database contents with respect to allowable fees for services and patient benefit calculations may change from plan to plan, depending on each plan's level of cooperation, technical sophistication and frequency (batch or real-time) in providing data to the Payment Management Computer 12.

Depending on the embodiment, elements of a customer database 13 may be omitted to the extent that the Payment Management Computer 12 can be connected to databases in other systems that already store the same information—for example, a healthcare provider's PMS or accounting system, or a plan's claims processing system. Such connections can be real-time or near-real-time interfaces, or, in the case of a PMS or accounting system, through the implementation of the Payment Management Computer 12 as a web service, in which its primary data requirements can be met by fetches from patient or fee schedule databases already resident within the PMS system database. The advantages of the web service are (1) it allows the Payment Management Computer 12 to be implemented as an extension to a system already within the provider environment; (2) it allows existing databases to be accessed by the Payment Management Computer 12 without the need to create and maintain two largely equivalent databases; and (3) it enables additional high-value functionality such as making it possible for the Payment Management Computer 12 to automatically update required fee schedules, or for the PMS or other accounting systems to post consumer payment transactions automatically.

The Payment Management Computer 12 may be implemented with any well-known device or set of devices that has processing power and memory, such as commercially available computing devices and servers.

FIG. 2 illustrates the setup and configuration process 90 that is required to prepare the payment management system 10 to manage patient payments for one or more healthcare providers 14. Most of the process steps are directed at securing the information to be stored in customer database 13, including data about system users; individual healthcare providers employed by or otherwise associated with healthcare providers 14; contract reimbursement schedules (also called fee schedules); patients; relationships between third-party payers 16, reimbursement contracts and fee schedules; relationships between patients and third-party payers 16; payments, and system control functions such as indicators about data sources and retrieval mechanisms (e.g., whether particular patient data is stored in the database 13 or in a shared database hosted by a PMS, or whether fees for services to patients with a particular plan should be estimated by the Payment Management Computer 12 based on fee schedules stored in the customer database 13 or should be retrieved from a direct connection to a payer or other outside system). These steps may be performed by personnel associated with the healthcare provider 14, or, by a contracted Operator of the Payment Management Computer 12 (in either case, the System Operator).

The setup and configuration process 90 begins when the System Operator reviews information requirements with a healthcare provider 14 (step 100) who wants to use the patient payment management system 10. To establish an account for healthcare provider 14, the System Operator collects information such as the depositary bank account into which card proceeds will be transferred and acceptable debit and credit card services (step 114). This information is then forwarded to the electronic payment processing control service 18, which, upon review and approval, establishes a merchant transaction processing account (step 116) for the healthcare provider 14 and provides the individual and system IDs and passwords required to access transaction processing functions and data.

The System Operator also collects information regarding the medical provider and provider staff associated with healthcare provider 14 (step 118) and uses this information to create log-on IDs and passwords for physicians and other staff as appropriate who will require access to the patient payment management system 10 (step 120).

In addition, the System Operator identifies specific healthcare providers within the healthcare provider 14 organization whose services are bundled for reimbursement purposes by insurance companies and health plans according to a standard practice in health claims processing. When services are “bundled” payers reduce their reimbursement for multiple medical services performed at the same time to a level below the sum of the individual fees for all of the services. Where known, bundling rules applicable to the healthcare provider 14 are identified (step 128) and then stored in the customer database 1 (step 136) so that the Payment Management Computer 12 can more accurately predict the patient's financial responsibility when multiple medical services are provided.

The System Operator then obtains data on the volume of medical procedures performed by the healthcare provider 14, classified by medical service code (generally a “procedure code”, or CPT®). This data may be made available from the Practice Management System (PMS) (step 102) or, if not, from an analysis of a 1 month sample of Explanations of Payment (EOPs) received from payers (step 104). The PMS, as used herein, refers to the software application that handles billing and accounting for healthcare provider 14. In either case, The System Operator identifies the highest volume procedures performed by the healthcare provider 14 (step 106). In most cases the 30-50 most frequently provided medical services for a healthcare provider will account for over 90 percent of its volume, so that accurate estimates of patient payments due for these services will ensure that most insured patients who pay at the time of service will have small or no settle-up adjustments when the payer EOP is received by the healthcare provider 14.

The next major set-up task is identifying the reimbursement contracts and payers with which the healthcare provider 14 and the individual healthcare providers practicing within it conduct business (step 112). In most cases, the PMS will be able to identify payers and reimbursement contracts by volume (step 108); if not, an analysis of a 1 month sample of EOPs will yield this information (step 110).

The purpose of identifying payers and contracts is so they may easily be linked to the patients they cover and so as many accurate contract fees as possible are available for quick and easy calculations of patient financial responsibility by the Payment Management Computer 12 while a patient is standing at the checkout station.

The calculation starts with the allowable amounts payer and network contracts allow (contract fees) the healthcare provider 14 to receive. “Allowable amount” refers to the total amount a physician or other medical provider has contracted to accept as full reimbursement for a specific medical service or set of services. Allowable amounts also include amounts a healthcare provider 14 has set as its price for services delivered to patients not in contract with any payer (a “self-pay” patient) or in contract with a payer that has no contractual relationship with healthcare provider 14 that would determine allowable amounts. The payment itself can come from the patient, a third-party payer (i.e. an insurer or health plan, including Medicare and Medicaid), or in many cases partly from the patient and the remainder from the health plan or insurance company (the payer). The payer determines how much it will pay to the healthcare provider 14 by starting with the allowable amount and then dividing responsibility for that amount between the patient and the payer on the basis of the patient's health care benefits. The resulting determination is then explained to the patient by the EOB sent to patient, and to the healthcare provider 14 by the payer's EOP that typically accompanies a reimbursement check or EFT transmittal.

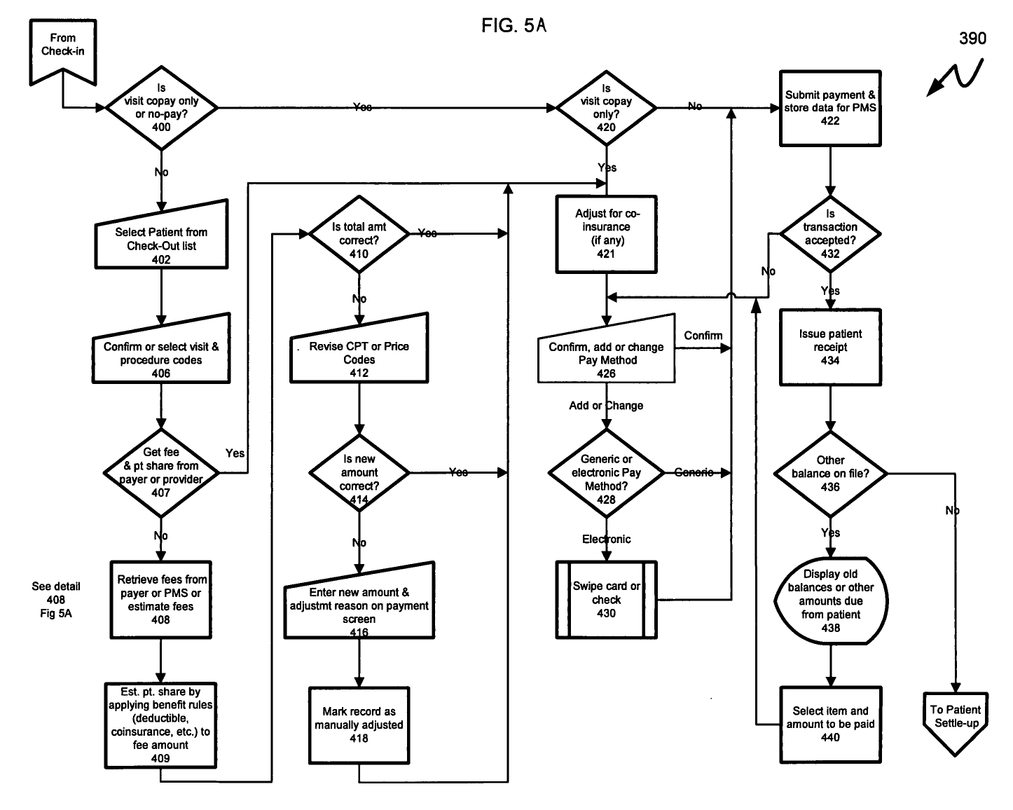

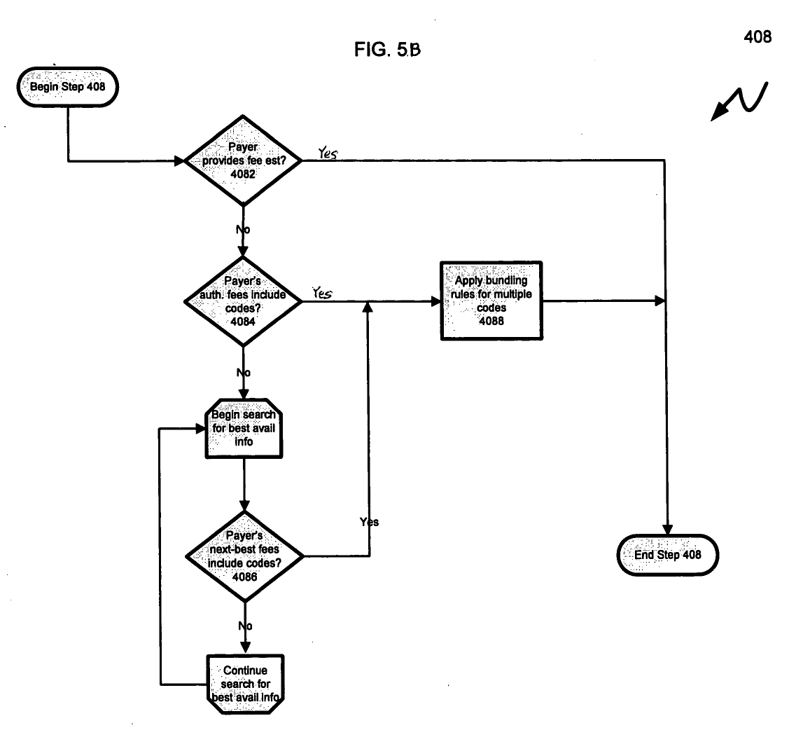

In other words, the central task of the Payment Management Computer 12 is anticipating the result of this determination before it occurs, thus letting the healthcare provider 14 explain to the patient what his or her responsibility for payment will be, and collecting that amount before he or she leaves the place where services were provided. The underpinnings for this task, which is explained further in the discussion of step 408 in FIG. 5A and FIG. 5B, are performed during the set-up and configuration process by steps 130, 131, 132, and 134. The following four steps are repeated for every third party payer.

1. Step 130 asks whether the payer has a real time capability to make its own estimate of the amount its insured patients owe using its internal fee schedules and information about the patient's benefits agreement, including information about the status of patient deductibles and out-of-pocket limits or information about the allowable amounts the healthcare provider may receive in connection with its services to the patient. If so, that capability may extend to all its insured patients or just to those patients in certain plans. If the payer does have this capability, and if the Payment Management Computer 12 can access that data while the patient is standing at the healthcare provider 14 check-out station, this data is stored in the customer database 13 (step 136) and the computer will retrieve the patient payment estimate or the allowable amount directly from the plan rather than calculating the former from data internal to the Payment Management Computer or retrieving the latter from fee schedules in database 13.

In many cases, the amount calculated by the plan will still be an estimate subject to revision, because the patient's benefit status may change between the time the initial calculation is made and the time the final claim is received from the healthcare provider and adjudicated. For example, another claim may arrive more quickly and exhaust the patient's deductible. The estimated amount will be final only if the information submitted to the payer consists of a complete claim that can be adjudicated on the spot—a very unusual situation today—or there is no further medical claims activity between the time the amount is estimated and the time the payer adjudicates the submitted claim.

2. Step 131 asks whether the PMS contains one or more fee schedules for a payer, or whether fee schedules are available from the payer. Medicare and Medicaid typically provide such schedules, as do other government-sponsored plans and some network administrators. In all such cases, the System Operator obtains the relevant fee schedules and stores them in the customer database 13.

3. For payers where neither direct payment data nor complete fee schedules are available, the System Operator implements a two-step solution. The first is to determine “authenticated” allowed amounts for at least the highest volume CPT codes (Step 132). “Authenticated” allowed amounts or fees are amounts communicated to healthcare provider 14 or otherwise verified by a payer or a payer's representative. The communication or verification can take the form of a complete or partial fee schedule, or responses to healthcare provider 14 requests to a payer's customer service department for fees for specific services, or fees for services published on the payer's web site, or fees allowed in response to claims submitted to the payer by healthcare provider 14. Authenticated fees may also be calculated by healthcare provider 14 or Payment Management Computer 12 from formulas provided by a payer or payer's representative that tie amounts allowed by a payer to publicly available information (e.g. fee allowed per Relative Value Unit, associated with medical service codes in specific files published by the Federal Center for Medicare and Medicaid Services). However they are obtained, all known authenticated allowed amounts (fees) for each payer 16 are stored in customer database 13 in the first of a series of fee schedules for that payer. The authenticated amounts in the initial fee schedule typically will provide accurate data for 90 percent or more of the services rendered by the healthcare provider 14 even if they only cover fees for the 20 to 40 highest volume medical service codes.

4. Step 134 estimates fees for CPT codes for which exact values are not known. These estimated fees are placed in one or more successive fee schedules, with each schedule including additional codes not found in any of the prior schedules and the fees in each schedule being calculated in an increasingly less precise way. Examples of alternative, increasingly approximate ways of estimating fees for additional codes would include multiplying local Medicare allowable amounts within a particular class of service code (e.g. all evaluation and management codes) by a multiplier equal to the average of all authenticated fees in the same class to the corresponding local Medicare fees; or multiplying all Medicare allowable amounts by a multiplier equal to the average ratio of all authenticated fees to the corresponding local Medicare fees; or similarly multiplying local Medicare fees by an empirically derived multiplier that, when applied to local Medicare charges for service codes associated with authenticated allowable amounts, produces a result acceptable to the healthcare service provider (e.g., no more than 10 percent of the resulting calculated amounts exceeded the corresponding authenticated allowable amounts); or multiplying local Medicare fees by a multiplier determined in a manner analogous to the determination of any of the above multipliers, but across a broad database of similar contracts with comparable service providers and/or payer in a defined market area; or multiplying local Medicare fees by a reasonable percentage based on experience in comparable markets and/or with comparable payers in other markets; or multiplying the Relative Value Units associated with each medical service code by a dollar amount determined in a manner analogous to the determination of any of the above multipliers but based on a quotient of authenticated fees divided by the Relative Value Units associated with the medical service codes of the authenticated fees. These typically are computed by comparing the exact fees for known high-volume codes (from step 132) with the corresponding local Medicare codes for the local geographic region, finding the best fit relationship between the two, and calculating estimated fees for remaining codes on the basis of that relationship and current Medicare prices. These estimates are stored in the second fee schedule of the payer's contracted fees.

As most private health plans and insurance companies do not release their complete fee schedules to their contracted healthcare providers, in the majority of cases the customer database 13 will have exact fees only for high volume CPT codes, and estimated fees for other codes. But the Payment Management Computer12 is nonetheless able to function as an all payer, all patient collection tool because it has a reasonable, data-based estimate of what the patient owes.

The last major set-up task is ensuring that patient data will be available to the Payment Management Computer and will not have to be entered into the payment management system 10 as patients arrive. The System Operator first checks to see if all or most of the patient data can be accessed directly from a PMS or other database (step 121), either via a real-time interface or because the patient payment management system 10 has been embedded in the PMS or other system that maintains a useable patient database. In either of these cases the customer database 13 needs only to contain instructions on where and how to obtain patient data, but does not need to duplicate details already in another system. If the data will not be available as needed from another system database, the System Operator checks to see if it can be extracted from the PMS as an electronic file (step 122) that can be transformed as needed and loaded into customer database 13 (step 136). Even if the patient data cannot be extracted from the PMS as an electronic file, it may be extracted in the form of a report that can be scanned to create a patient data file (steps 124 and 126).

All the tasks previously noted on FIG. 2A—obtaining the merchant approval issued by the electronic payment processing control service 18 (step 116), the login ID and password created for the staff (step 120), identifying appropriate code bundling rules for the healthcare provider 14 (step 128), and the development of contractual fee schedules (steps 130 to 134)—let the System Operator create a customer database (step 136), where the “customer” is healthcare provider 14.

The System Operator, working with designated personnel associated with the healthcare provider 14, has a number of non-data oriented set up tasks to perform as well in order to ensure the payment management system 10 functions smoothly day-to-day. These include defining appropriate patient financial policies that describe the patient's obligation to pay at the time of service (step 140), providing materials explaining the policies and processes to the patients and to the staff of healthcare provider 14 (step 142), and training the healthcare provider 14 on use of the financial policies and the Payment Management Computer 12 (step 144). Once these are completed and the customer database has been created the payment management system 10 is activated for live operations (step 146).

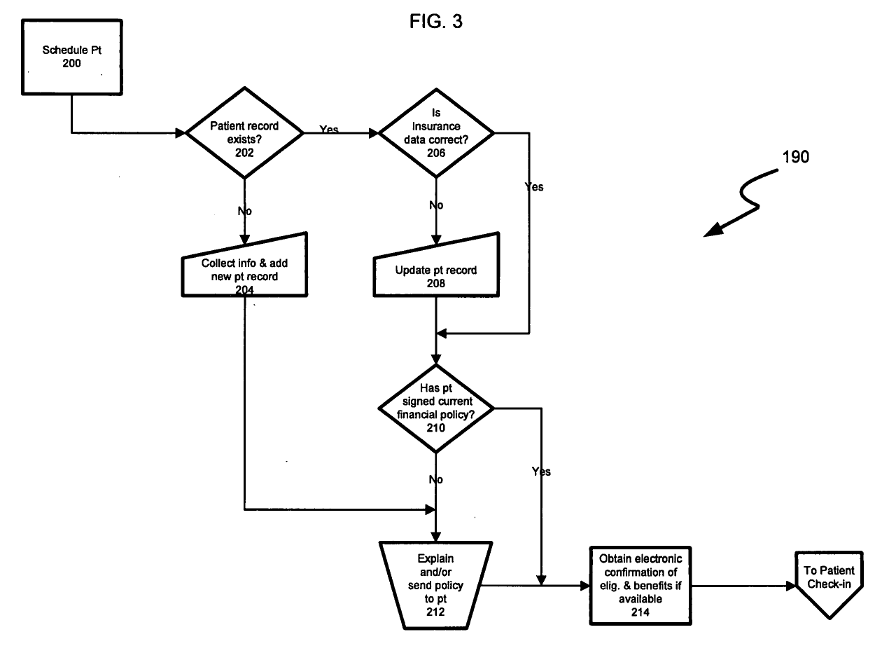

FIG. 3 is a flowchart illustrating the patient scheduling and patient data collection process 190 executed by the payment management system 10 when a patient schedules a medical service appointment (step 200). The Payment Management Computer 12 checks to see if customer database 13 or its alternative patient database already has a record of the patient (step 202). If the patient record does not exist, the Payment Management Computer 12 collects and stores in the patient database information including demographic data such as birth date, address, email address, as well as healthcare coverage information such as health insurer name, group and personal IDs, and basic benefits (step 204). The person scheduling the appointment then explains the patient financial policy adopted by healthcare provider 14 and/or sends a copy of the policy to the new patient (step 212).

If the Payment Management Computer 12 confirms that the patient requesting the appointment already has a record in the patient database, then the person scheduling the appointment confirms the patient's insurance information. If the information differs from the information in the patient record, the record is updated (step 208). The person scheduling the system also checks the patient record to see if the existing patient has signed the current financial policy and, if not, proceeds to explain and send the policy as above (step 212).

At this point in all branches of the process, the Payment Management Computer 12 may issue an eligibility and benefits query for an insured patient and the results of the inquiry will be stored in the patient database (step 214).

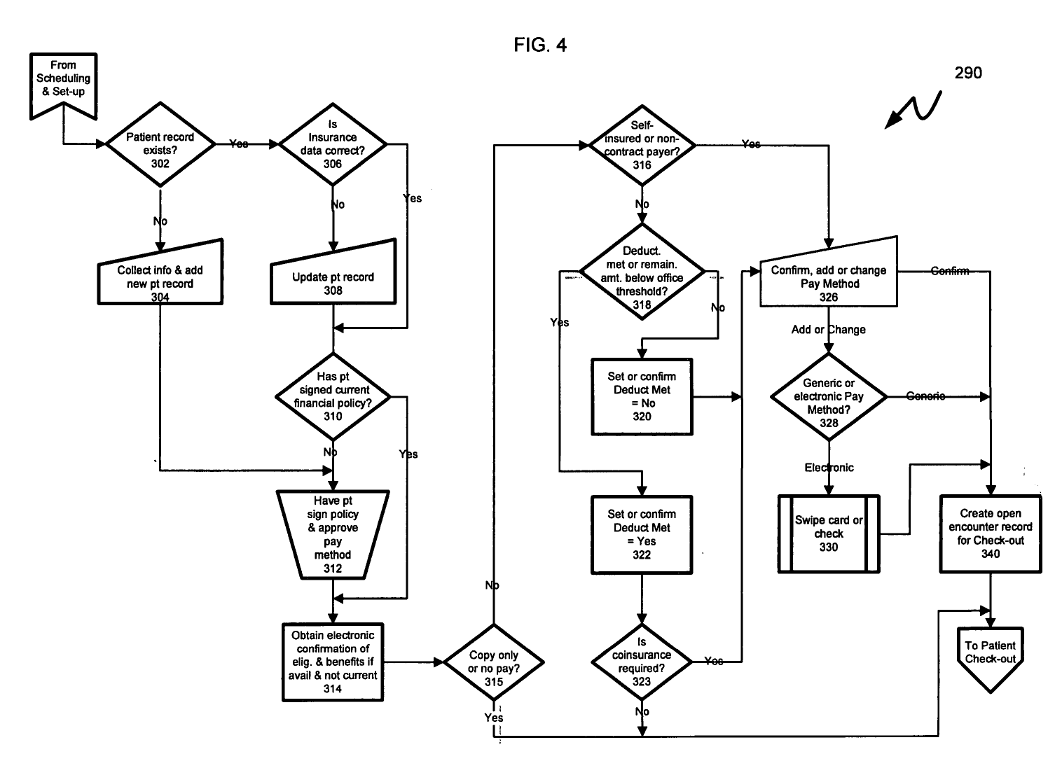

FIG. 4 is a flowchart illustrating the patient check-in and encounter setup process 290 that is executed by the payment management system 10. The initial steps of this process—steps 302 through 314—parallel steps 202 through 214 in the patient scheduling and data collection process described in FIG. 3. Most patients who have scheduled their appointment in advance will already have a record in customer database 13 available to the Payment Management Computer 12. However, the system user will check either the patient's insurance card or the results of the electronic eligibility and benefits transaction obtained at the end of the scheduling process (step 214) to enter or confirm insurance information such as group and member IDs, copay amounts, deductibles and coinsurance (step 306), and the patient will be asked to sign the patient financial policy and initial his or her choices of electronic payment method(s) if he or she has not already done so (step 312).

If the patient's benefits show that only a flat dollar copayment is owed, or no payment is owed (step 315), the Payment Management Computer 12 transfers control to the patient check-out and collection process 390 (see FIG. 5A).

At this point, if the patient is self-insured or insured by a payer that does not have a fee agreement with the healthcare provider 14 or the specific physician treating the patient (step 316), the Payment Management Computer 12 prompts the system user to see which pay methods the patient will use for his or her current visit, and which pay method the healthcare provider 14 should use to pay or refund any settle-up amount when the payer issues an EOP (step 326).

If the patient is in contract with a third-party payer 16 that is also directly or indirectly in contract with the patient's healthcare provider, the Payment Management Computer 12 determines whether the patient's deductible, if any, has been satisfied or if the amount remaining is below the threshold amount set by the healthcare provider 14 (step 318). If the answer is No, the patient will be responsible for a payment in connection with today's visit. The system user confirms that the “deductible met” flag in the patient's record is set to No (step 320). The Payment Management Computer 12 prompts the system user to confirm, change, or add a new pay method for the current visit (step 326).

If the deductible has been satisfied or the deductible amount remaining is below the threshold, the system user ensures that the “deductible met” flag in the patient's record is set to Yes (step 322) and the Payment Management Computer 12 checks to see if the patient has a coinsurance requirement (Step 324). If the answer is Yes, The Payment Management Computer 12 prompts the system user to confirm, change, or add a new pay method for the current visit (step 326) as above. If the answer is No, the patient will have no responsibility for payment in connection with today's visit and the Payment Management Computer transfers control to the patient check-out and collection process 390 (see FIG. 5A).

Every patient except those who can demonstrate they have no payment obligation confirms the pay methods they wish to use for the current visit and to settle-up any difference between the estimated amount that will be collected at the time of the visit and the final amount due determined by the payer (step 326). The pay method used for the current visit can be “generic”—cash, or a paper check that is not scanned, or a one-time ACH transaction—or “electronic”. The pay method for the settle-up amount is preferably an electronic pay method in order for the healthcare provider 14 to eliminate patient billing.

An electronic pay method is created by scanning a check or credit or debit card—including a card associated with a patient Health Savings Account (HSA)—and capturing, encrypting and storing in customer database 13 (which is stored in a physically and electronically secure server) bank or card account information that under the terms of the patient financial policy can be used on an ongoing basis by the healthcare provider 14 (step 330). The pay method is given a name consisting of the type of card or account plus the last four digits of the bank account or card number; this name is the only information about the account visible to or known by healthcares services 14 staff, and it is used to help office staff and patients identify the accounts patients want to use to pay their obligations at the time of service or for settle-up.

Once one or more pay methods have been added for the patient, and other visit identification—the clinician with whom the appointment has been made and the place of service—have been selected the Payment Management Computer 12 creates an open encounter record for check-out (step 340) and the patient proceeds with his or her appointment before returning to check-out before leaving the healthcare facility.

FIG. 5A is a flowchart illustrating the patient check-out and payment process 390 executed by the payment management system 10.

If the patient is checked out immediately upon checking in because it has been determined there is no patient payment responsibility for this visit (steps 400 and 420), the check-in staff person will submit a zero-pay transaction to close the visit (step 422). The Payment Management Computer 12 will then alert the staff person of any outstanding balances for this patient related to earlier visits or miscellaneous charges (step 436) , and the system user may display the nature and amount of other payments due (step 438). The system user will enter each amount to be paid by the patient (step 440), who will then confirm the pay method he or she wishes to use (step 426). A separate payment transaction will be used for each amount (step 422), simultaneously creating a payment record for transmission to or entry in the practice management system so that each payment can be tied directly to the visit or other activity that produced the original charge.

If the patient starts this process with the determination that he or she will have to pay a copay only (steps 400 and 420), Payment Management Computer 12 or the check-out staff person will examine the patient record to determine whether the patient has coinsurance with a secondary payer also in contract with the service provider, in which case the amount to be collected by patient may be reduced (step 421). Following this determination, the patient confirms, adds or changes the pay method selected for this visit, following steps 426 through 432, which are exactly parallel to steps 326 though 332 in the check-in process except that the exit from these steps leads to submit payment and record payment data (step 422) instead of to the creation of an open encounter record, after which the process, including handling outstanding balances, proceeds as in the preceding paragraph and the check-out process will be completed by the check-in person.

If the patient is self-insured or insured by a payer that does not have a fee agreement with the healthcare provider 14 or the specific physician treating the patient, or if an insured patient's benefits include a deductible or coinsurance, with or without a copayment, the patient goes to a checkout workstation in the healthcare service provider office at the conclusion of the medical service appointment. The patient's record is selected from the list of open encounters in database 13 by the healthcare provider 14 check-out person (step 402). If the procedure codes for services provided during the visit have been retrieved from an electronic medical record, the checkout person inspects them for reasonableness and proceeds. Otherwise, the patient presents a form from the healthcare provider that lists common procedures provided in the practice. The form has been marked by the medical professionals providing services to the patient during his or her visit to indicate which medical services were provided during the appointment, either by checking off common procedure codes or writing in procedure codes. Healthcare provider 14 check-out staff checks off or enters those same procedures on the encounter record in the Payment Management Computer 12 (step 406).

If the patient is self-insured or insured by a payer that does not have a fee agreement with the healthcare provider 14, the Payment Management Computer 12 determines from the patient record whether the patient should be charged at the healthcare provider 14 full billed charge or a discounted charge based on the patient's identification as a hardship case in customer database 13 and retrieves the appropriate fees from database 13 (step 407). Alternatively, if an insured patient's third-party payer 16 can provide an electronic transaction with either actual (based on real-time adjudication) or estimated amounts for the allowed amount and amount to be collected from the patient (see step 130 in set-up and configuration process 90), Payment Management Computer 12 will initiate a request for that transaction. In all of these cases, control then transfers from step 407 directly to step 421, checking to see if patient has secondary insurance coverage from a payer in contract to healthcare provider 14 that could reduce either the service provider's fee or the amount to be collected from the patient and then proceeding to the collection process. If none of the preceding conditions are satisfied, control transfers instead to step 408

Payment Management Computer 12 automatically retrieves (step 408) the fee or fees for services received based on the identity of the medical provider who rendered the service and the identity of the third-party payer who has contracted with both the patient and the service provider. This process for determining allowed amounts is described in connection with FIG. 5B below).

For a patient with a third-party payer who cannot provide either an adjudicated or estimated amount due from the patient, Payment Management Computer 12 calculates the amount due from the patient by applying the patient's benefit information to the total allowed amount retrieved in step 408, first applying any copay amount to the total allowed amount, then any remaining deductible amount and then the percentage of coinsurance to any balance of the allowable fee that remains after subtracting the copay and deductible (step 409). Alternatively, if any remaining deductible amount could reasonably be expected to be low or zero by the time the patient's third-party payer adjudicates a claim to determine the exact amount due from the patient, healthcare provider 14 could instead elect to forego the application of any deductible amount and instead apply a coinsurance percentage to the entire balance of the total allowed amount less the patient's copay.

The healthcare provider 14 reviews the results (step 410) and if the results appear incorrect, may revise either the CPT procedure codes or the pricing codes used by Payment Management Computer 12 (e.g., to note that a procedure that will not be paid by the patient's insurer may still need to be charged at a reduced rate specified in the payer's fee schedule) and resubmits the checkout transaction (step 412). If the new amount is still incorrect (step 414), the system user with appropriate authority may make further adjustments (step 416), until the results appear correct to the healthcare provider 14. If corrections to CPT or pricing codes were not sufficient to produce an acceptable result, the system user may enter the amount to be collected at the time of service with a code explaining why the automated results of the Payment Management Computer 12 were not accepted. For audit purposes, the payment amount is permanently tagged as having been determined manually rather than by Payment Management Computer rules. At this point the Payment Management Computer 12 requires the system user to confirm, add, or change pay methods for the current visit (steps 426 through 432, discussed above), after which the user will submit the payment due at the completion of the current visit and record the payment data for the PMS (step 422), issue a hard copy and/or email receipt (step 432), and then deal with any remaining balances as outlined at the beginning of the description of check-out process 390.

FIG. 5B is a flowchart illustrating the details of the process executed by Payment Management Computer 12 to determine the “preliminary allowed amount” that will be received by healthcare provider 14 for the services the insured patient received today (i.e. step 408). The “preliminary allowed amount” may be either the actual allowed amount or a best estimate of what the actual allowed amount is, depending on what data is available. To determine the preliminary allowed amount, the Payment Management Computer 12 looks at one or more sources in a predefined order. When the preliminary allowed amount is determined, the Payment management Computer 12 stops looking. As this predefined order is in the order of decreasing accuracy, the first preliminary allowed amount that is encountered is the most precise of the available value representing/estimating the predetermined allowed amount.

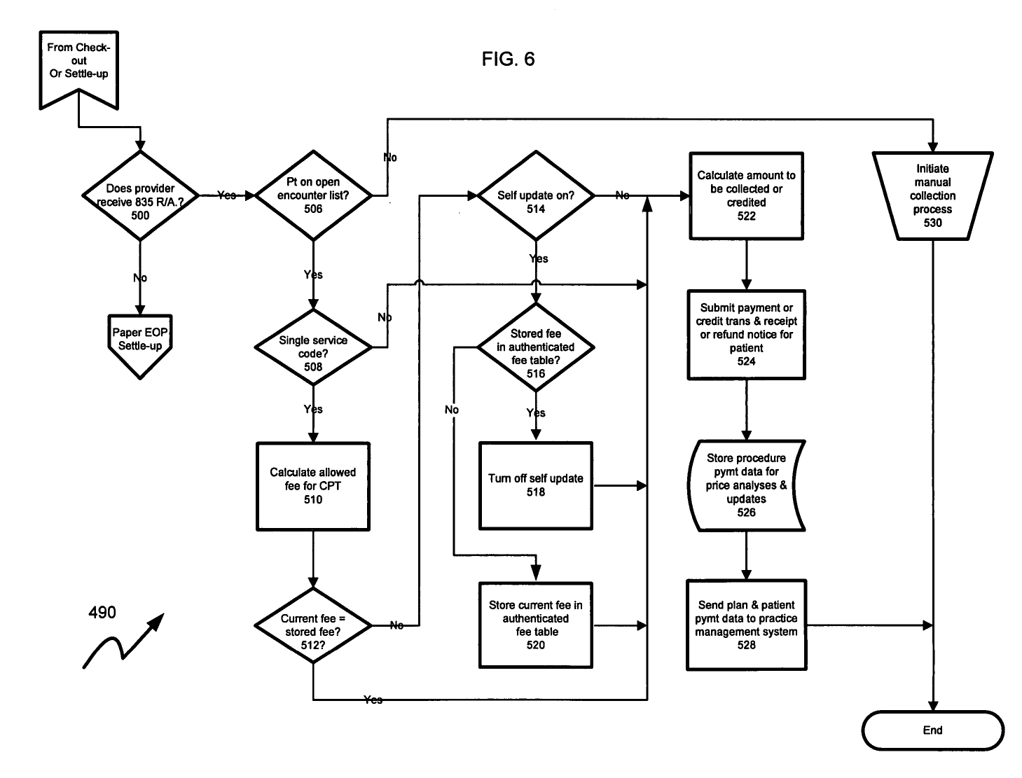

If the patient's third-party payer can provide a real-time value or estimated value of the amount the healthcare provider will receive for the service provided to the patient (a capability determined in step 130), Payment Management Computer 12 initiates a request for that information (step 4082). Otherwise, Payment Management Computer 12 retrieves a preliminary allowed amount from one or more payer-supplied or system-created fee schedules stored in customer database 13 (steps 131, 132 and 134 above) and maintained by processes 490, 590 and 690 described in FIG. 6 through 8.

It the payer cannot provide a real-time value or estimate, the Payment Management System 12 first checks (step 4084) to see if a CPT code being priced is in the schedule of authenticated allowed amounts created in step 131 or 132 of set-up process 90 and updated by step 516 or 616 in settle-up process 490 or 590, or by steps 724 through 730 of the fee schedule and maintenance process 690.

If any medical service codes and fees for procedures performed do not appear in the schedule of authenticated fees, the Payment Management Computer 12 Payment Management System 12 accesses in turn the successive fee schedules created in step 134 of set-up process 90. These schedules contain increasingly imprecise estimates of fees but increasingly complete coverage (i.e. more codes and fees), including in some cases special codes used only by the healthcare services provider 12 (e.g., codes for missed appointments or special requests for copies of medical records) as well as a fallback schedule used for any codes not included in earlier fee schedules. The search process is shown as a repeating loop, within which a less precise but more comprehensive schedule is searched each time the process returns to step 4086.

In determining the total fee(s) that will be received by the service provider in connection with multiple services, Payment Management Computer 12 takes applicable bundling rules created in step 128 into account (step 4088). If the impact of applicable bundling rules cannot be determined from electronic or other information supplied by a patient's third-party payer or another third party service that provides such information, a conservative approximation may be obtained simply by using the fee associated with the most expensive single service provided as the basis for collection on the date of service.

FIG. 6 is a flowchart illustrating the first of two alternative processes for handling posting and settle-up. The purpose of the posting and settle-up process is to compare the amount collected from a patient at the time of service with the amount a patient's insurer determines the patient should pay after adjudicating the claim submitted by healthcare provider 14. The insurer's determination is communicated to healthcare provider 14 by an electronic remittance advice or a paper Explanation of Payment (EOP), and to the insured patient by the Explanation of Benefits (EOP). In either case, the determination typically occurs days (more frequently weeks) after the date of service, so the settle-up process is executed by payment management system 10 when the patient is not at healthcare provider 14's facility. Note that this process never occurs for self-pay patients or patients who are insured by payers that do not have a contractual fee arrangement with healthcare provider 14, as the payment management system 10 allows healthcare provider 14 to collect the full amounts due from these patients at the time they receive services.

The alternative described in this flowchart, process 490, assumes the payer has returned an electronic remittance advice (HIPAA 835) to healthcare provider 14 that can be accessed by the Payment Management Computer 12 and used to execute a reconciliation process that minimizes data entry and the likelihood that manual physical bill will have to be mailed to the patient. If an electronic remittance advice is not available, the Payment Management Computer 12 will instead guide healthcare provider 14 billing personnel through the paper-based settle-up process 590 (step 500).

The Payment Management Computer 12 then searches for an “open”, or unreconciled, encounter (step 506) created by check-out process 390 that matches the encounter described by the remittance advice. If it cannot find a matching transaction in customer database 13, it initiates a manual collection process (step 530).

If Payment Management Computer 12 finds the encounter described by the HIPAA 835 remittance advice, it then checks to see if both the remittance advice and the open encounter identified in step 506 involve only one medical service code (step 508). If not, the Payment Management Computer 12 proceeds immediately to calculate the difference between the amount collected from the patient at the time of service with the total amount due per the remittance advice. (i.e. the “settle-up amount—step 522), which may be an additional payment due from the patient or a refund due to the patient. Payment Management Computer 12 then retrieves the electronic pay method designated for use in this settle-up transaction that was stored in customer database 13 during check-in process 390 at the beginning of the patient visit and uses it to generate a debit or credit transaction equal to the settle-up amount (step 524). To complete the transaction, Payment Management Computer 12 also generates either an email or paper notice to the patient (depending on the patient's communication preference stored in customer database 13) explaining the amount collected or refunded. Note that healthcare provider 14 may choose to queue these payment transactions and then submit them individually in order to monitor and respond as quickly as possible to pay method or transaction problems, rather than letting the automated process handle a large batch of claims transactions contained within a single HIPAA 835 remittance advice and then have to work from error logs to diagnose problems after the fact. Regardless of how the payment or credit transactions are processed, Payment Management Computer 12 then stores various transaction data for fee schedule updates and error analyses (step 526). As a final step, Payment Management Computer 12 forwards payment transaction data to the healthcare provider 14 practice management system, its financial system of record. This may be a batch or real-time process, or will be unnecessary if the payment management system 10 is embedded in the PMS. This process is largely automated, but the system user at healthcare provider 14 has the option to intervene and perform a guided reconciliation if the medical service codes or other data on the remittance advice do not match exactly the data on the encounter stored in customer database 13. and the settle-up amount is calculated, etc., as above.

If the remittance advice and open encounter identified in step 506 do involve only one medical service code, Payment Management Computer 12 calculates the “allowed amount” (i.e. the total fee to be received by healthcare provider 14 from the combination of the payer and the patient) the payer has used in its determination of the amount owed by the patient (step 510). It then compares this amount with the amount currently stored in the payer fee schedule for the same medical service code. If the amounts are the same, control transfers to step 522 and processing proceeds as above.

If the amounts are not the same, Payment Computer 12 checks the status of the self update switch for this payer (step 514), which could have been set to Off or On by steps 703 or 704 of periodic fee and contract maintenance process 690). If the switch is off, control transfers to step 522 and the settle-up amount is calculated, etc., as above.

If the self update switch is on, Payment Management Computer 12 then checks to see if the stored fee was retrieved from an authenticated source or fee schedule. If the stored fee was not from an authenticated source, the allowed amount authorized by the payer in the current transaction is treated as an authenticated amount and stored in the authenticated fee table, and control transfers to step 522 to complete the processing of the current encounter as before.

However, if the stored fee was retrieved from an authenticated source, control instead transfers to step 518, which turns off the self update switch and transfers control to step 522 to complete the reconciliation process for the current encounter as above, without first updating the authenticated fee table. The reason is that any mismatch between the fee allowed on a current claim and an authenticated fee signals an error that needs to be researched and corrected in accordance with the periodic fee and contract maintenance process 690.

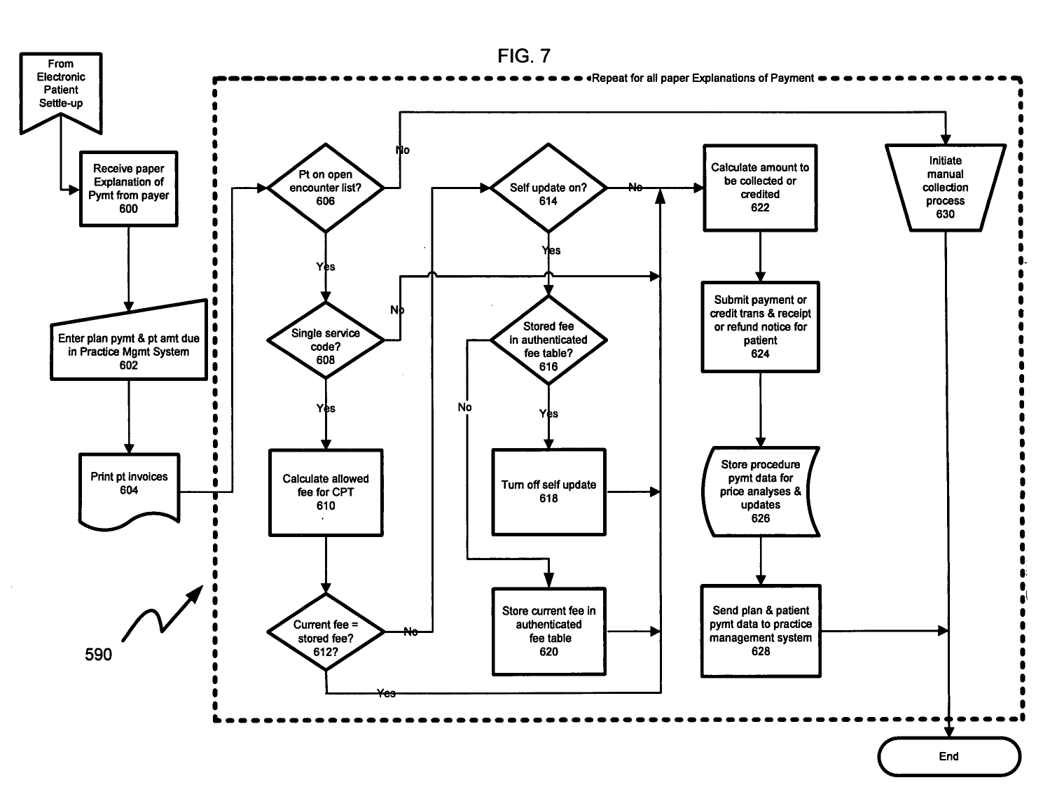

FIG. 7 describes the paper EOP posting and settle-up process 590 executed by the payment management system 10 when a payer sends healthcare provider 14 paper Explanations of Payment (step 600) instead of electronic remittance advices.

Healthcare provider 14 will first enter the information from the paper EOPs into the practice management system (PMS) (step 602). After a number of EOPs have been entered, or at scheduled intervals, healthcare provider 14 generally will print patient invoices as a batch process (step 604). In this case, the PMS will have calculated the settle-up amount based on the EOP determination of patient obligation versus the time-of-service payment data stored in the PMS in the course of check-out process 490. The PMS may be able to identify and separate invoices for customers who have an approved electronic pay method stored in customer database 13. Alternatively, the system user can generate a report of all open encounters that occurred on the dates for which EOPs have been received, which the user can use to sort the invoices printed by the PMS (step 608) into those that will have to be mailed and follow-up manually (step 608) versus those for whom the settle-up transaction can be performed electronically by Payment Management Computer 12.

From that point forward the process described by steps 606 through 630 is substantially similar to that set forth in steps 506 through 530 of post and settle-up process 490 above, except that the invoice input documents (as opposed to electronic remittance advices) are processed one at a time and the data from paper EOPs will in most cases already have been posted to the PMS and the only additional data to be sent will the step 624 collection transactions.

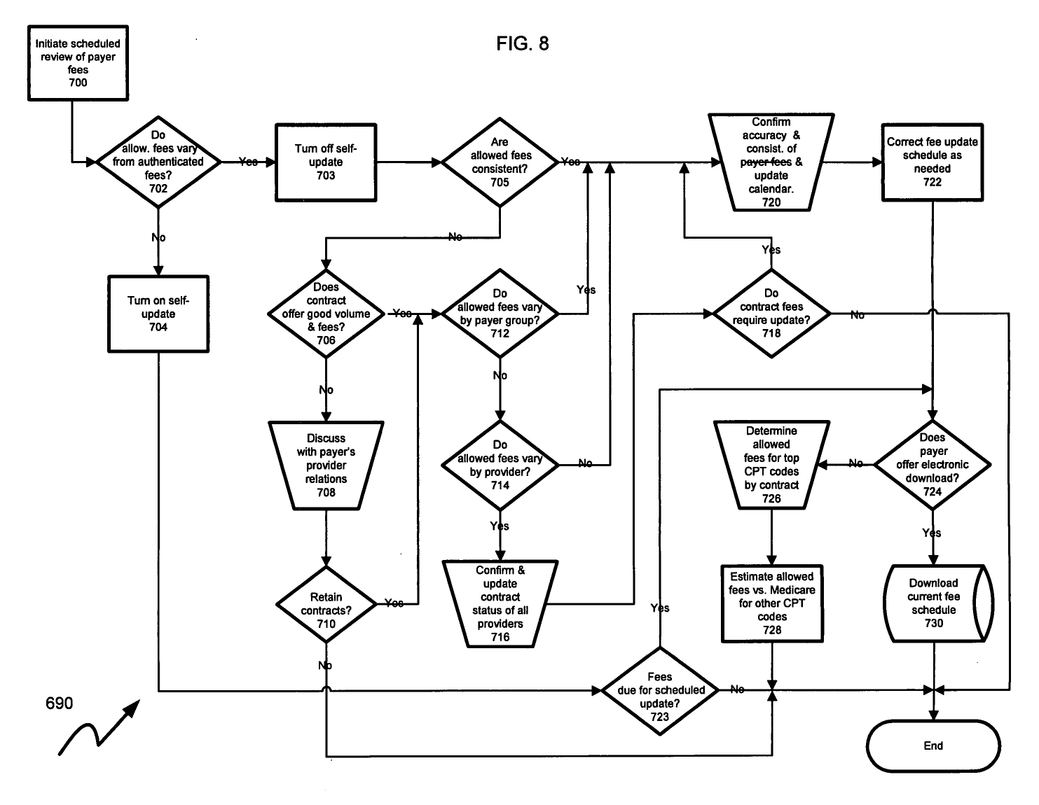

FIG. 8 is a flowchart illustrating the periodic fee schedule and contract maintenance process 690 that is executed by the payment management system 10. The steps outlined in this process are initiated (step 700) with varying frequencies for each payer contract and associated fee schedule stored in customer database 13, with more intensive scrutiny focused on higher volume payers that do not provide fee schedule to healthcare provider 14 on a regular basis. Their goals are to use information captured by settle-up processes 490 and 590 (steps 526 and 626) to monitor the ongoing accuracy of stored fee schedules and payer claims adjudication; the consistency of healthcare provider 14 contracting policies; and the financial attractiveness of the payment contracts executed both by healthcare provider 14 as an organization and by individual care providers within the organization.

The initial task performed by Payment Management Computer 12 is determining whether some or all of the fees a payer has allowed in recent encounters vary from fees stored in an authenticated fee schedule stored in customer database 13. The Payment Management Computer 12 makes this determination on the basis of the data stored during posting and settle-up processes 490 (step 516) and 590 (step 616). If the authenticated fees for a number authenticated service codes are different but consistent (step 705), the payer fee schedule differs from the schedule stored in customer database 13 or, if the payer provides fee information through real-time transactions at the time of service, the payer's information services and adjudication schedules are inconsistent and the reasons for the differences need to be identified and resolved with the payer (step 720).

If the allowed fees paid by the payer are inconsistent, the initial question raised for healthcare provider 14 is whether the payer contract offers reasonable fees and accounts for significant revenues (step 706). If the payer relationship appears to be attractive, healthcare provider 14 will use Payment Management Computer 12 to determine whether the variation in fees corresponds to variations in the payer groups in which patients are enrolled (step 712), or to variations in the identity of individual healthcare service providers (step 714). If fees vary by provider, healthcare provider 14 will review and update the contract status of all its individual service providers both in fact and as described in customer database 13, making required corrections (step 716) and then deciding whether contracted fees need to be updated as well (step 718). In any other case, healthcare provider 14 will check with the payer to confirm the status of its fee contracts for groups and providers and their representation in customer database 13 (step 720)

If a payer with inconsistent fees is not deemed to be an attractive contractual partner (step 706), healthcare provider 14 would discuss both the inconsistent payments and level of fees with the payer and decide whether to retain or terminate the payer contract (steps 708 and 710), and, if the payer is retained, determine and implement required corrective actions as above (steps 712 through 722). If the contract is to be terminated, associated references and fee schedules will be removed from the system upon the effective date of the termination.

If the settle-up process 490 and 590 do not reveal differences between fee schedules in database 13 and the allowed amounts reported by health plans and insurance companies, Payment Management Computer 12 turns on the self-update function for this fee schedule. As long as this switch remains on, allowable fees reported settle-up processes 490 and 590 it is preferable to conduct periodic fee schedule updates. Hence the Payment Management Computer 12 tracks scheduled updates (steps 722 and 723) as part of periodic fee schedule and contract maintenance process 690. When an update is required for payers that offer an electronic download of fee schedules (step 724), the Payment Management Computer 12 can request and/or receive the updates automatically and store them in database 13 (step 730). For payers that do not offer downloadable fee schedules, healthcare provider 14 determines exact fees for high volume CPT codes and prepares estimates for other fees based on the relationship to Medicare fees shown by the high volume procedures and then updates customer database 13 accordingly (see discussion of steps 132 and 134 in set-up and configuration process 90).

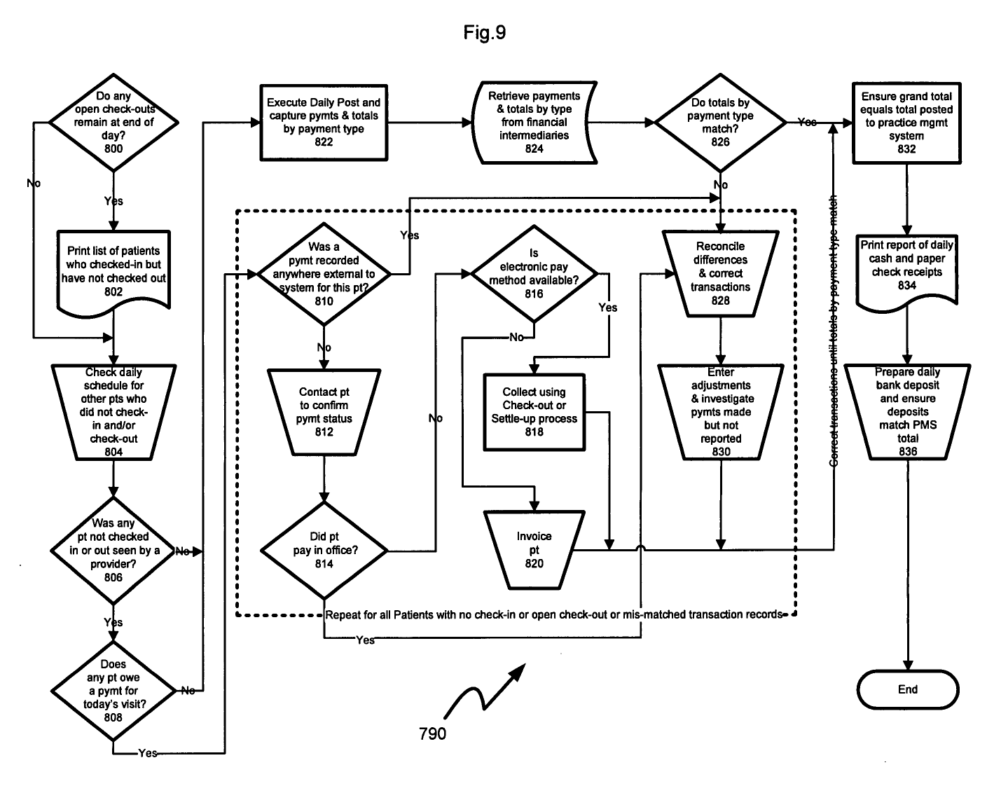

FIG. 9 is a flowchart illustrating the financial control process executed by the payment management system 10. This process reveals and corrects collected but unrecorded patient payments, missed patient payment collection opportunities, and differences between the financial results in Payment Management Computer 12, the PMS at the healthcare provider 14, and external financial reports and transactions such as bank statements and amounts recorded through electronic payment processing control service 18. Patients who checked in but did not check out through the payment management system 10 may have either left without stopping to pay, or paid, perhaps in cash, amounts that were not recorded and could be subject to employee theft. To identify such problems, healthcare provider 14 prints a list of patients checked in but not checked out for that business day (step 802) and compares it to a list from the daily appointment schedule of patients who did not check in or did not check out (step 804). Healthcare provider 14 investigates to see if any of these patients are no-shows or otherwise did not see a provider or complete a visit (step 806). Next, healthcare provider 14 conducts an evaluation and resolution process to determine if any patients who met with a provider and completed a visit owed money for the visit (step 808), and for each of these patients, whether they checked in, checked out, and owe a payment for the visit.

If a patient is indicated as owing money, the healthcare provider 14 reviews any logs or systems external to payment management system 10 where a payment might have been recorded, for example, a note in a patient chart or on a paper schedule (step 810). If none are found, the patient is contacted (step 812) to see if he or she did make a payment in the office (step 814). If not, and the patient has an electronic pay method in database 13 (step 816), the payment is processed and collected electronically (step 818). If not, and the patient has no electronic pay method, the patient is sent a paper invoice (step 820). If a record of a collected payment is found, a transaction reflecting the collection is entered and reconciled (step 828).

When all patients who received services for the day have been properly recorded in Payment Management Computer 12, or there are no open check-outs or check-ins in either Payment Management Computer 12 or the appointment scheduling system, Payment Management Computer 12 executes the daily posting and reports payments and totals by type of transaction (step 822). The Payment Management Computer 12 also retrieves the same data from electronic payment processing control service 18 (step 824) and compares the totals from each (step 826) so that the healthcare provider 14 reconciles any differences (step 828). Any necessary adjusting transactions are recorded in Payment Management Computer 12 and healthcare provider 14's PMS (step 830).

When totals by payment type in Payment Management Computer 12 and electronic payment processing control service 18 are reconciled, the totals are posted to the PMS (step 832). The last step is the printing the report of daily cash and paper check receipts (step 834) which in turn balance to the PMS total for the day and is the source document for the daily bank deposit (step 836).

While the foregoing has been with reference to particular embodiments of the invention, it will be appreciated by those skilled in the art that changes in this embodiment may be made without departing from the principles and spirit of the invention. For example, while certain functionalities are described as being executed by the Payment Management Computer 12 and other functionalities are described as being executed by the healthcare provider 14, these functionalities may be assigned differently depending on the particular embodiment. functionalities are described as being executed by the Payment Management Computer 12 and other functionalities are described as being executed by the healthcare service provider 14, these functionalities may be assigned differently depending on the particular embodiment.

1. A computer-based method of collecting payment for a service, the method comprising:
capturing a service that is rendered for a service recipient by a service provider;
determining if there is a third party payer in contract with the service recipient to pay at least part of the cost for the service;
if there is a third party payer in contract with the service recipient,
determining a relationship between the third party payer and the service provider;
using the relationship to determine a preliminary allowed amount to be collected by the service provider for the service; and
determining a first portion of the preliminary allowed amount that is to be collected from the service recipient for the service; and
automatically collecting the first portion of the preliminary allowed amount from the service recipient on the date of service.

2. The method of claim 1 further comprising if there is no third party payer in contract with the service recipient, determining that the first portion is equal to the preliminary allowed amount.

3. The method of claim 2 further comprising constructing a fee schedule containing charges for services to be collected from the service recipient in cases where no payment is collected from a third party payer.

4. The method of claim 2 further comprising constructing a fee schedule containing charges to be collected from the service recipient where the third party payer has no relationship with the service provider.

5. The method of claim 2, wherein determining the first portion comprises:
determining whether the service recipient is a hardship case; and
accessing a different schedule of fees depending on the determination.

6. The method of claim 1 further comprising making an electronic inquiry to a database that links the identity of the third party payer to one or more sources for determining the preliminary allowed amount.

7. The method of claim 6 further comprising making a series of electronic inquiries to different sources until the preliminary allowed amount is determined.

8. The method of claim 6, wherein some of the sources contain a fee schedule that prescribes the preliminary allowed amounts for various services.

9. The method of claim 8 further comprising periodically updating the fee schedule based on actual allowed amounts for recent services that are provided.

10. The method of claim 8 further comprising updating the fee schedule based on information from the third party payer.

11. The method of claim 8 further comprising:
monitoring discrepancies between the preliminary allowed amounts and the actual allowed amount for collection by the service provider; and
adjusting the fee schedule based on the discrepancies.

12. The method of claim 6, wherein the database links the identity of the third party payer to multiple fee schedules including a first fee schedule and one or more subsequent fee schedules, further comprising querying the multiple fee schedules in a predefined sequence until the preliminary allowed amount for the service is obtained.

13. The method of claim 12, wherein the first fee schedule in the predefined sequence contains authenticated preliminary allowed amounts for services.

14. The method of claim 13, wherein the subsequent fee schedules in the predefined sequence contain estimates of preliminary allowed amounts for services not listed in the first fee schedule.

15. The method of claim 14 further comprising determining which estimates of preliminary allowed amounts to authenticate by identifying the highest-volume service likely to be performed by the service provider.

16. The method of claim 14 further comprising replacing the estimates with actual allowed amounts as additional services are provided.

17. The method of claim 12, wherein the predefined sequence is determined such that fee schedules are reviewed in an order of decreasing level of precision.

18. The method of claim 1, wherein determining the first portion comprises determining the first portion conservatively to avoid over-collecting from the service recipient.

19. The method of claim 1 further comprising collecting from the third party payer on the date of service after the third party payer confirms its payment responsibility and amount to be collected by the service provider.

20. The method of claim 1 further comprising receiving, on the date of service and from the third party payer, an estimated amount that is collectible by the service provider.

21. The method of claim 1 further comprising submitting an eligibility and benefits inquiry about the service recipient to at least one of the third party payer, a clearinghouse, and transaction service provider.

22. The method of claim 1 further comprising using eligibility and benefits information about service recipients to determine the first portion.

23. The method of claim 1 further comprising:
receiving information from the third party payer; and
using the information to determine the first portion regardless of the form or accuracy of the information, thereby providing a universal platform for different third party payers.

24. The method of claim 1 further comprising automatically charging at least some of the first portion of the fee to the service recipient's electronic payment account.

25. The method of claim 1, wherein collecting the first portion further comprises:
accessing the service recipient's financial account; and
automatically transferring payment from the service recipient's financial account to a service provider's deposit account.

26. The method of claim 1, wherein the service is a healthcare service and the service recipient is a patient, further comprising storing payment method information for the service recipient such that additional payment is collected after the service provider receives the third party payer's Explanation of Benefit or Remittance Advice.

27. The method of claim 1, wherein the collecting is performed automatically using previous stored patient and healthcare provider financial account information and calculated amounts due.

28. The method of claim 1 further comprising:
reconciling an amount that is collected on the date of service with a collection amount according to an Explanation of Payments or Remittance Advice; and
automatically collecting or crediting a difference between the amount that is collected and the collection amount from or to the service recipient's financial account.

29. The method of claim 1 further comprising generating a control report after the collecting, wherein the control report contains at least one of the following information:
total collection by payment type;
collection by service recipient;
list of patients checked-in but not checked-out and for whom no service or collection was noted; and
a marking indicating that automatically calculated amount is manually over-ridden.

30. A computer-readable storage medium storing instructions capable of being executed by a computer, the instructions comprising:
instructions to capture a service that is rendered for a service recipient by a service provider;
instructions to determine if there is a third party payer in contract with the service recipient to pay at least part of the cost for the service;
instructions to determine a relationship between the third party payer and the service provider, use the relationship to determine a preliminary allowed amount to be collected by the service provider for the service, and determine a first portion of the preliminary allowed amount that is to be collected from the service recipient for the service if there is a third party payer in contract with the service recipient; and
instructions to automatically collect the first portion of the preliminary allowed amount from the service recipient on the date of service.

31. The computer-readable storage medium of claim 30 further comprising instructions to determine that the first portion is equal to the preliminary allowed amount if there is no third party payer in contract with the service recipient.

32. The computer-readable storage medium of claim 31 further comprising instructions to construct a fee schedule containing charges for services to be collected from the service recipient in cases where no payment is collected from a third party payer.

33. The computer-readable storage medium of claim 31 further comprising instructions to construct a fee schedule containing charges to be collected from the service recipient where the third party payer has no relationship with the service provider.

34. The computer-readable storage medium of claim 31, wherein instructions to determine the first portion comprises:
instructions to determine whether the service recipient is a hardship case; and
instructions to access a different schedule of fees depending on the determination.

35. The computer-readable storage medium of claim 30 further comprising instructions to make an electronic inquiry to a database that links the identity of the third party payer to one or more sources for determining the preliminary allowed amount.

36. The computer-readable storage medium of claim 35 further comprising instructions to make a series of electronic inquiries to different sources until the preliminary allowed amount is determined.

37. The computer-readable storage medium of claim 35, wherein some of the sources contain a fee schedule that prescribes the preliminary allowed amounts for various services.

38. The computer-readable storage medium of claim 37 further comprising instructions to periodically update the fee schedule based on actual allowed amounts for recent services that are provided.

39. The computer-readable storage medium of claim 37 further comprising updating the fee schedule based on information from the third party payer.

40. The computer-readable storage medium of claim 37 further comprising:
instructions to monitor discrepancies between the preliminary allowed amounts and the actual allowed amount for collection by the service provider; and
instructions to adjust the fee schedule based on the discrepancies.

41. The computer-readable storage medium of claim 35, wherein the database links the identity of the third party payer to multiple fee schedules including a first fee schedule and one or more subsequent fee schedules, further comprising querying the multiple fee schedules in a predefined sequence until the preliminary allowed amount for the service is obtained.

42. The computer-readable storage medium of claim 41, wherein the first fee schedule in the predefined sequence contains authenticated preliminary allowed amounts for services.

43. The computer-readable storage medium of claim 42, wherein the subsequent fee schedules in the predefined sequence contain estimates of preliminary allowed amounts for services not listed in the first fee schedule.

44. The computer-readable storage medium of claim 43 further comprising instructions to determine which estimates of preliminary allowed amounts to authenticate by identifying the highest-volume service likely to be performed by the service provider.

45. The computer-readable storage medium of claim 43 further comprising instructions to replace the estimates with actual allowed amounts as additional services are provided.

46. The computer-readable storage medium of claim 41, wherein the predefined sequence is determined such that fee schedules are reviewed in an order of decreasing level of precision.

47. The computer-readable storage medium of claim 30, wherein the instructions to determine the first portion comprises instructions to determine the first portion conservatively to avoid over-collecting from the service recipient.

48. The computer-readable storage medium of claim 30 further comprising instructions to collect from the third party payer on the date of service after the third party payer confirms its payment responsibility and amount to be collected by the service provider.

49. The computer-readable storage medium of claim 30 further comprising instructions to receive, on the date of service and from the third party payer, an estimated amount that is collectible by the service provider.

50. The computer-readable storage medium of claim 30 further comprising instructions to submit an eligibility and benefits inquiry about the service recipient to at least one of the third party payer, a clearinghouse, and transaction service provider.

51. The computer-readable storage medium of claim 30 further comprising instructions to use eligibility and benefits information about service recipients to determine the first portion.

52. The computer-readable storage medium of claim 30 further comprising:
instructions to receive information from the third party payer; and
instructions to use the information to determine the first portion regardless of the form or accuracy of the information, thereby providing a universal platform for different third party payers.

53. The computer-readable storage medium of claim 30 further comprising instructions to automatically charge at least some of the first portion of the fee to the service recipient's electronic payment account.

54. The computer-readable storage medium of claim 30, wherein the instructions to collect the first portion further comprises:
instructions to access the service recipient's financial account; and
instructions to automatically transfer payment from the service recipient's financial account to a service provider's deposit account.

55. The computer-readable storage medium of claim 30, wherein the service is a healthcare service and the service recipient is a patient, further comprising instructions to store payment method information for the service recipient such that additional payment is collected after the service provider receives the third party payer's Explanation of Benefit or Remittance Advice.

56. The computer-readable storage medium of claim 30, wherein the instructions to collect comprises instructions to collect automatically using previously stored patient and healthcare provider financial account information and calculated amounts due.

57. The computer-readable storage medium of claim 30 further comprising:
instructions to reconcile an amount that is collected on the date of service with a collection amount according to an Explanation of Payments or Remittance Advice; and
instructions to automatically collect or credit a difference between the amount that is collected and the collection amount from or to the service recipient's financial account.

58. The computer-readable storage medium of claim 30 further comprising instructions to generate a control report after the collecting, wherein the control report contains at least one of the following information:
total collection by payment type;
collection by service recipient;
list of patients checked-in but not checked-out and for whom no service or collection was noted; and
a marking indicating that automatically calculated amount is manually over-ridden.
